(19) United States
(12) Patent Application Publication
(10) Pub. No.: US 2004/0165752 A1
(43) Pub. Date: Aug. 26, 2004

(54) Identification method, data storage medium for identification and reading device for identification

(76) Inventors: Markus Junginger, Gundelfingen (DE); Dietmar Fischer, Unterhaching (DE)

Correspondence Address: RATNERPRESTIA, P O BOX 980, VALLEY FORGE, PA, 19482-0980, US

(21) Appl. No.: 10/417,950

(22) Filed: Apr. 17, 2003

(30) Foreign Application Priority Data
Feb. 26, 2003 (DE) 10308302.2

(51) Int. Cl. G06K 9/00

(52) U.S. Cl. 382/115

(57) ABSTRACT

The present invention relates to a biometric identification method and apparatus, in which at least one biometric feature of at least one person is recorded with a reading device. The data thus obtained are coded and sent to a data storage medium via a cryptographically secured line and decoded there by a microprocessor located on the data storage medium. The decoded data are compared with the reference data stored on the data storage medium, and an identification signal is generated in case of a nearly complete agreement. The present invention further relates to a data storage medium and a reading device for use with a biometric identification method according to the present invention.

### FIELD OF THE INVENTION

The present invention relates to a biometric identification method and apparatus. More specifically, the present invention is a biometric identification method and apparatus in which at least one biometric feature is recorded and compared with reference data in order to perform identification or verification of a user.

### BACKGROUND OF THE INVENTION

Physical properties of a person, e.g., the face, the iris or fingers are measured in biometry in order to confirm the unambiguous identity of the person. Security measures are currently performed by means of personal identification numbers (PINs), passwords or auxiliary means, e.g., tokens. These conventional approaches have drawbacks, however, because such security measures can be stolen, lost or passed on to grant other persons unauthorized access to the secured object. The use of biometric methods is intended to guarantee that the registered person is indeed standing in front of the reading device.

Biometric devices and methods used hitherto store the data on various data storage media, such as a hard disk or chip card. The reference sample is read by a digital evaluating system, e.g., a PC, from the chip card for the comparison of the reference sample with the biometric feature currently being measured and is compared in the internal main memory of the reading device with the data set currently being generated.

One drawback of this approach, however, is that a hacker is able to come into possession of the original data set by manipulating the device (e.g., the evaluating unit with corresponding espionage software, etc.) or compromise a communications pathway (e.g., a cable). Furthermore, there is a risk that the original reference data set is manipulated or even replaced before the checking by the evaluating system. An unauthorized person may thus gain access to protected objects and at the same time incriminate another person with it.

### SUMMARY OF THE INVENTION

In view of the shortcomings of the prior art, an object of the present invention is to provide a biometric identification method, a data storage medium that can be used for this purpose and a reading device that can be used for this purpose, which offer the highest possible level of security.

One aspect of the present invention is a biometric identification method. The method comprises the steps of recording at least one biometric feature of at least one person using a reading device; (b) encoding at least one biometric feature recorded in step (a); (c) transmitting the encoded data to a data storage medium; decoding the data on the data storage medium; comparing the decoded data with reference data stored on the data storage medium; and generating an identification signal based on the comparison.

According to another aspect of the invention, the data transmitted in step (b) is transmitted via a cryptographically secured line.

According to a further aspect of the invention, the at least one biometric feature comprises at least one of i) an iris pattern of a user and ii) a fingerprint pattern of the user.

According to still another aspect of the invention, the method further comprises the step of generating a positive identification signal based on a substantially complete match of the decoded data with the reference data

According to yet a further aspect of the invention, the method at least one biometric feature each from at least two persons is read for generating a positive identification signal.

According to still a further aspect of the invention, the method further comprises the steps of reading respective biometric features from each of the at least two persons; coding the respective biometric features; sending the respective biometric features via a cryptographically secured line to the data storage medium; comparing the respective biometric features with reference data stored on the said data storage medium; and generating an identification signal based on a substantial agreement of the data of the at least two persons with the corresponding reference data stored on the said data storage medium.

According to another aspect of the present invention a medium for use with the biometric identification method comprises a secured area for storing the reference data, the reference data based on at the least to one biometric feature of at least one person; a read-in section for receiving data via a cryptographically secured line; a microprocessor for decoding the data received via the read-in section and comparing the data with the reference data stored in the secured area; and signal generating means for at least one of generating and transmitting the identification signal when the data nearly agree with the reference data.

According to still another aspect of the present invention, a reading device for use with the biometric identification method comprises at least one recording means for recording the at least one biometric feature; coding means for coding data associated with the at least one biometric feature; and a transmission means for transmitting the coded data to the data storage medium.

According to yet a further aspect of the present invention, a biometric identification apparatus comprises means for recording at least one biometric feature of at least one person; means for coding the at least one biometric feature; means for transmitting the coded data to a data storage medium; means for decoding the data on the data storage medium; means for comparing the decoded data with reference data stored on the data storage medium; and means for generating an identification signal based on the comparison.

These and other aspects of the invention are set forth below with reference to the drawings and the description of exemplary embodiments of the invention.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following FIGURES:

FIG. 1 is an illustration of a data storage medium according to an exemplary embodiment of the present invention.

### DETAILED DESCRIPTION OF THE INVENTION

With the biometric identification method according to the present invention, at least one biometric feature of a person is recorded with a reading device and the thus data obtained are coded. The data are transmitted to a data storage medium via a cryptographically secured line. It is only at the data storage medium that the data are decoded by a microprocessor located on the data storage medium and compared with reference data stored on the data storage medium itself. If there is an at least nearly complete agreement between the data and the reference data, a corresponding identification signal is generated, which authorizes, e.g., access.

The agreement of the data must be nearly complete. Slight deviations must, of course, be recognized and ignored to a certain extent, because the biometric feature itself is also subject to change. The tolerance threshold may be selected correspondingly depending on the desired degree of security.

The original reference sample does not leave the data storage medium in the biometric identification method according to the present invention. Consequently, the data of the reference sample do not have to be sent to another device for comparison via a possibly hackable communications pathway. A hacker cannot gain access in this manner to the reference data being stored on the data storage medium. This offers the highest level of security and personal data protection.

The term “identification” is used for the purposes of this text as a generic term for the authentication or verification and/or the identification of the person. Typical applications are, e.g., the control of access to places that shall be accessible to authorized persons only, or the control of access to automatic means such as cash dispensers (ATMs) or data processing units. The reference data of the authorized person are stored on the data storage medium during the authentication/verification (one-to-one comparison). To carry out a method for determining the identity, the reference data of several persons are stored and the identity of the person can be determined (one-to-one comparison).

All biometric properties of a person, e.g., the face, are suitable for use as a biometric feature for carrying out the exemplary biometric identification method. However, evaluations of the iris or the fingerprint or the fingerprints are especially advantageous, because they have a high level of unchangeable characterizing features.

In another exemplary embodiment of the biometric identification method according to the present invention, a positive identification signal is generated only when the data of a plurality of biometric features agree with the reference data stored on the data storage medium.

The method according to the present invention may also be used, e.g., such that access is possible only in case of the positive identification/authentication of a plurality of persons. A corresponding data storage medium, which is used in the manner according to the present invention, may be provided in this case for the biometric features of every individual person. For example, access is granted only in case of the presence of positive identification signals concerning the evaluated biometric features of both persons. This method may, of course, also be implemented for any desired number of persons.

In another advantageous embodiment, the biometric data read from two or more persons must agree with the corresponding reference data, which are stored on a data storage medium, in order to generate a positive identification signal. The reference data are stored in this case on a single data storage medium, which also assumes the comparison of the biometric data read out for at least two persons.

In yet another exemplary embodiment of this method according to the present invention, the agreement of different biometric features of different persons are necessary for generating a positive identification signal. For example, it may be necessary for access that the iris scan of one person and the fingerprint scan of another person must be compared with the respective reference data.

Various media, e.g., USB tokens (Universal Serial Bus Tokens), may be used as data storage media. So-called smart cards are especially practical and simple to handle.

A data storage medium according to the present invention has a secured area for the storage of reference data of at least one biometric feature and of at least one person. A read-in section is provided for receiving data via a cryptographically secured line. Furthermore, the data storage medium according to the present invention has a microprocessor for decoding data read in via the read-in section and for comparing the data with the reference data stored in the secured area. A signal generating means is used to generate a signal, e.g., an electric or electronic signal for generating an identification signal when the data nearly agree with the reference data.

If a biometric identification method according to the present invention shall be carried out, in which different biometric features of optionally different persons are used for access control, the data storage medium according to the present invention has the possibility of storing the reference data of different biometric features of optionally different persons in the secured area according to one exemplary embodiment.

In case of the use of, e.g., a smart card, this electric or electronic signal may be output via electrical terminals present on the smart card and used to grant access.

A reading device according to the present invention for use with a biometric identification method according to the present invention has at least one recording device for recording a biometric feature, a coding means for coding the data of the biometric feature recorded, and a transmission means for transmitting the coded data to a data storage medium.

Depending on the embodiment, the reading device may optionally have a plurality of recording means for different biometric features of a plurality of persons, which shall be compared with reference data on the data storage medium.

An embodiment of the method according to the present invention will be explained in greater detail below on the basis of the FIGURE attached.

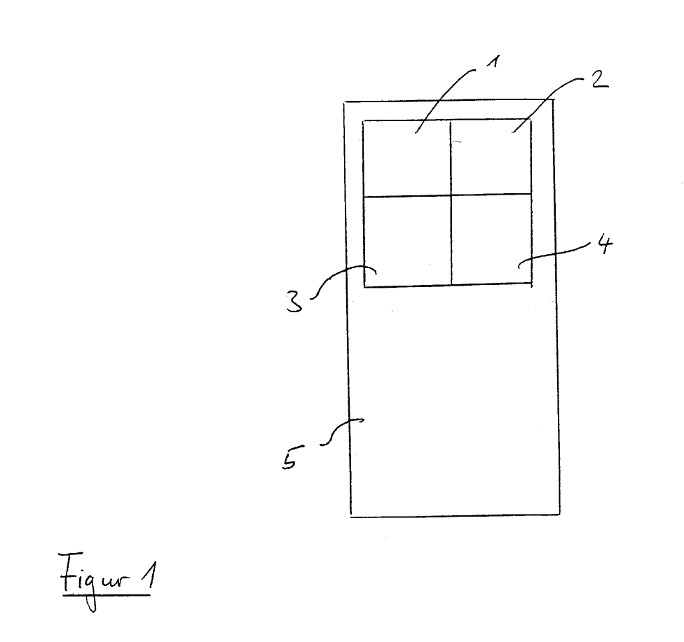

Referring now to FIG. 1 a schematic view of a data storage medium according to the present invention for carrying out a biometric identification method according to the present invention is shown.

An embodiment using smart card 5 is shown. An algorithm section 1, a read-in section 2, a data storage module 3 and a microprocessor 4 are located on smart card 5.

The original reference sample of the biometric feature to be evaluated is written in advance into the read-in section 2 of the card. The sample is read by the microprocessor 4 and written into the secured data storage module 3. The data of the original reference sample are supplied by a read-out unit here, which had recorded the biometric feature to be evaluated.

The smart card 5 is inserted into a reading device for verification or identification, e.g., as an access control. At the same time, the biometric feature is recorded by the reading device, coded and written on the read-in section 2 of smart card 5 via a cryptographically secured line. The sample is then read by the microprocessor 4 of smart card 5. The original reference data are read in by the microprocessor 4 from the secured data storage module 3 and compared with one another by means of the microprocessor 4 in the algorithm section 1. In case of a nearly complete agreement, the microprocessor 4 sends a corresponding signal via the read-in section 2 to an external system, which will then make access possible.

In another exemplary embodiment of the method, biometric features of two different persons are read in and compared with reference data that are present on a smart card and stored in a secured area.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A biometric identification method comprising the steps of:
(a) recording at least one biometric feature of at least one person using a reading device;
(b) coding at least one biometric feature recorded in step (a);
(c) transmitting the data coded in step (b) to a data storage medium;
(d) decoding the data on the data storage medium;
(e) comparing the data decoded in step (d) with reference data stored on the data storage medium; and
(f) generating an identification signal based on the comparison of step (e).

2. The method according to claim 1, wherein the data transmitted in step (b) is transmitted via a cryptographically secured line.

3. The method according to claim 1, wherein the at least one biometric feature comprises at least one of i) an iris pattern of a user and ii) a fingerprint pattern of the user.

4. The method according to any of claims 1-3, further comprising the step of generating a positive identification signal based on a substantial match of the decoded data with the reference data.

5. The method according to claim 1, wherein at least one biometric feature each from at least two persons is read for generating a positive identification signal.

6. The method according to claim 5, further comprising the steps of:
reading respective biometric features from each of the at least two persons;
coding the respective biometric features;
sending the respective biometric features via a cryptographically secured line to the data storage medium;
comparing the respective biometric features with reference data stored on the said data storage medium; and
generating an identification signal based on a substantial agreement of the data of the at least two persons with the corresponding reference data stored on the said data storage medium.

7. The method according to claim 5, in which different biometric features are read out, transmitted and compared for the identification of the at least two persons.

8. The method according to claim 1, wherein the data storage medium is a smart card.

9. A data storage medium for use with the biometric identification method according to claim 1, the storage medium comprising:
a secured area for storing the reference data, the reference data based on at the least to one biometric feature of at least one person;
a read-in section for receiving data via a cryptographically secured line;
a microprocessor for decoding the data received via the read-in section and comparing the data with the reference data stored in the secured area; and
signal generating means for at least one of generating and transmitting the identification signal when the data nearly agree with the reference data.

10. A reading device for use with the biometric identification method according to claim 1, the reading device comprising:
at least one recording means for recording the at least one biometric feature;
coding means for coding data associated with the at least one biometric feature; and
a transmission means for transmitting the coded data to the data storage medium.

11. A biometric identification method comprising the steps of:
reading respective biometric features from each of the at least two persons;
transmitting the respective biometric features via a cryptographically secured line to a data storage medium;
comparing the respective biometric features with reference data stored on the data storage medium; and
generating an identification signal based on a substantial agreement of the data of the at least two persons with the corresponding reference data stored on the data storage medium.

12. A biometric identification apparatus comprising:
means for recording at least one biometric feature of at least one person;
means for coding the at least one biometric feature;
means for transmitting the coded data to a data storage medium;
means for decoding the data on the data storage medium;
means for comparing the decoded data with reference data stored on the data storage medium; and
means for generating an identification signal based on the comparison.
